(19) United States
(12) Patent Application Publication
(10) Pub. No.: US 2024/0356052 A1
(43) Pub. Date: Oct. 24, 2024

(54) FUEL CELL EXHAUST GAS SYSTEM, AND METHOD FOR OPERATING A FUEL CELL SYSTEM

(71) Applicant: Purem GmbH, Neunkirchen (DE)

(72) Inventor: Gerd Gaiser, Reutlingen (DE)

(21) Appl. No.: 18/629,529

(22) Filed: Apr. 8, 2024

(30) Foreign Application Priority Data
Apr. 6, 2023 (DE) 10 2023 108 806.8

(51) Int. Cl. H01M 8/04701; H01M 8/04007; H01M 8/04746

(52) U.S. Cl. CPC H01M 8/04716; H01M 8/04074; H01M 8/04768; H01M 8/04776; H01M 2250/20

(57) ABSTRACT

A fuel cell exhaust gas system includes a fuel cell arrangement outputting a fuel cell exhaust gas, an ambient air heating arrangement for heating ambient air to provide heated ambient air and, a fuel cell exhaust gas/ambient air mixing arrangement configured for receiving the fuel cell exhaust gas and the heated ambient air and being configured to thoroughly mix the heated ambient air with the fuel cell exhaust gas.

### CROSS-REFERENCE TO RELATED APPLICATIONS

This application claims priority of German patent application no. 10 2023 108 806.8, filed Apr. 6, 2023, the entire content of which is incorporated herein by reference.

### TECHNICAL FIELD

The present disclosure relates to a fuel cell exhaust gas system and to a method for operating a fuel cell system which has a fuel cell arrangement and a fuel cell exhaust gas system.

### BACKGROUND

In a fuel cell system which is used, for example, in a vehicle for the generation of electrical energy, an anode exhaust gas which is enriched comparatively greatly with water or water vapor and/or a cathode exhaust gas which is enriched comparatively greatly with water or water vapor arise/arises during the conversion of an anode gas which contains hydrogen (H₂) and is fed to an anode region of a fuel cell arrangement and a cathode gas which contains oxygen (O₂) and is fed to a cathode region of the fuel cell arrangement, depending on the type of fuel cell arrangement which is used. If fuel cell exhaust gas which is enriched greatly in this way with water or water vapor and contains or includes the anode exhaust gas and/or the cathode exhaust gas is output to the surroundings at a comparatively low ambient temperature, an intensive mist formation can occur in the case of the contact of the water-containing fuel cell exhaust gas with the comparatively cool ambient air at the outlet location of the fuel cell exhaust gas as a result of water which condenses out. This is not only undesirable for visual reasons, but rather there is the risk that ice is formed as a result of the water which condenses out in the case of a low ambient temperature and, in particular, a cold underlying surface and which is precipitated on the underlying surface.

### SUMMARY

It is an object of the present disclosure to provide a fuel cell exhaust gas system and a method for operating a fuel cell system, by way of which the risk of a mist formation during the output of fuel cell exhaust gas into the surroundings can be counteracted effectively.

In accordance with a first aspect of the present disclosure, this object is achieved by way of a fuel cell exhaust gas system, in particular for the provision of electrical energy in a vehicle, including:

a fuel cell exhaust gas/ambient air mixing arrangement for receiving fuel cell exhaust gas, output by a fuel cell arrangement, and heated ambient air and for outputting a fuel cell exhaust gas/ambient air mixture,

an ambient air heating arrangement for heating the ambient air which is to be fed to the fuel cell exhaust gas/ambient air mixing arrangement for thorough mixing with the fuel cell exhaust gas.

By virtue of the fact that, in the case of a fuel cell exhaust gas system constructed according to the disclosure, heated ambient air is added to the fuel cell exhaust gas which is enriched greatly with water or water vapor, it becomes possible, before output of the fuel cell exhaust gas or the mixture which is generated from the fuel cell exhaust gas and the heated ambient air, for this mixture to be provided with a relative humidity of considerably below 100%. If, during the output from the fuel cell exhaust gas system, this mixture with a considerably reduced relative humidity in comparison with the fuel cell exhaust gas comes into contact with comparatively cold ambient air, the risk that the relative humidity reaches or exceeds a value of 100% as a result of spontaneous cooling of the mixture and therefore a mist formation occurs is reduced considerably.

In order for it to be possible for the ambient air which is to be mixed in a heated state with the fuel cell exhaust gas to be heated efficiently without an additional input of energy and/or without use of electrical energy which is generated in a fuel cell system, it is proposed that the ambient air heating arrangement includes a heat exchanger which can be flowed through by ambient air which is to be fed to the fuel cell exhaust gas/ambient air mixing arrangement and by a fuel cell cooling medium which flows in a fuel cell cooling circuit, for the transmission of heat contained in the fuel cell cooling medium to the ambient air which is to be fed to the fuel cell exhaust gas/ambient air mixing arrangement.

In order to regulate the temperature of the ambient air which is to be mixed in a heated state with the fuel cell exhaust gas, it is proposed that the ambient air heating arrangement is assigned a flow throttling arrangement for throttling the quantity, flowing through the ambient air heating arrangement, of the ambient air which is to be fed to the fuel cell exhaust gas/ambient air mixing arrangement.

In order to thoroughly mix the fuel cell exhaust gas with the heated ambient air, the fuel cell exhaust gas/ambient air mixing arrangement can include a mixing volume which receives the ambient air which is output by the ambient air heating arrangement and the fuel cell exhaust gas.

The thorough mixing of the heated ambient air with the fuel cell exhaust gas can be assisted by the fact that the mixing volume is assigned a fuel cell exhaust gas/ambient air mixing arrangement for mixing the ambient air which is introduced into the mixing volume with the fuel cell exhaust gas which is introduced into the mixing volume.

In the case of an embodiment which can be realized simply in structural terms, the mixing volume can include a, that is to say a single, mixing chamber which receives the fuel cell exhaust gas, that is to say the entire fuel cell exhaust gas which is to be mixed with heated ambient air, and the ambient air which is output by the ambient air heating arrangement, that is to say the entire heated ambient air which is to be mixed with the fuel cell exhaust gas.

In order to efficiently assist the thorough mixing of fuel cell exhaust gas and heated ambient air in the mixing chamber, it is proposed that the mixing chamber includes a plurality of ambient air inlet openings for introducing ambient air into the mixing chamber and/or a plurality of fuel cell exhaust gas inlet openings for introducing fuel cell exhaust gas into the mixing chamber.

The ambient air/fuel cell exhaust gas mixing arrangement can include at least one mixer assigned to the mixing chamber. This mixer can be arranged, for example, in the mixing chamber.

In order to increase the efficiency of the thorough mixing of the fuel cell exhaust gas and heated ambient air, it is proposed that the mixing volume includes a plurality of mixing chambers, each mixing chamber being configured to receive a part of the fuel cell exhaust gas and a part of the ambient air which is output by the ambient air heating arrangement.

In the case of an embodiment of this type with a plurality of mixing chambers, the fuel cell exhaust gas/ambient air mixing arrangement can include at least one mixer assigned to each mixing chamber. For example, in each case one mixer of this type can also be arranged in a respective mixing chamber in an embodiment of this type.

In order to further reduce the relative humidity before outputting the mixture of fuel cell exhaust gas and ambient air, it is proposed that an ambient air adding arrangement is provided to add ambient air to the fuel cell exhaust gas/ambient air mixture which is output by the fuel cell exhaust gas/ambient air mixing arrangement.

For the treatment of the fuel cell exhaust gas which is output by a fuel cell arrangement, a fuel cell exhaust gas treatment arrangement can be arranged upstream of the fuel cell exhaust gas/ambient air mixing arrangement. The fuel cell exhaust gas treatment arrangement can include at least one of the following assemblies:

liquid separator,

catalytic converter,

silencer.

The disclosure relates, furthermore, to a fuel cell system, including a fuel cell arrangement and a fuel cell exhaust gas system which is constructed according to the disclosure, receives the anode exhaust gas and/or cathode exhaust gas output by the fuel cell arrangement as fuel cell exhaust gas, and outputs it to the surroundings with a relative humidity which is decreased in comparison with the received fuel cell exhaust gas.

The disclosure relates, furthermore, to a method for operating a fuel cell system, for example a fuel cell system with the construction according to the disclosure, in the case of which method a mixture is produced from fuel cell exhaust gas, output by a fuel cell arrangement of the fuel cell system, and ambient air, at least one part of the ambient air which is added to the fuel cell exhaust gas being heated before mixing with the fuel cell exhaust gas.

Since, as a result of the addition of heated ambient air to the fuel cell exhaust gas which is output by a fuel cell arrangement, the relative humidity of the mixture which is produced in this way has already been decreased considerably in comparison with the relative humidity of the fuel cell exhaust gas which is output by the fuel cell arrangement, a further decrease in the relative humidity can be achieved by virtue of the fact that unheated ambient air is added to the mixture of fuel cell exhaust gas and heated ambient air.

For an efficient and energy-saving provision of the mixture of fuel cell exhaust gas and heated ambient air, it is proposed that the ambient air which is to be mixed in a heated state with the fuel cell exhaust gas is heated in a heat exchanger by way of thermal interaction with a fuel cell cooling medium which flows in a fuel cell cooling circuit.

In order for it to be possible for the decrease in the relative air humidity to be achieved or set to a required extent even depending on the surrounding conditions, in particular the ambient temperature, in order to set a temperature of the ambient air to be heated in the heat exchanger, a mass flow of the ambient air which flows through the heat exchanger and/or a mass flow of the fuel cell cooling medium which flows through the heat exchanger can be changed.

In order to provide the mixture of heated ambient air and fuel cell exhaust gas, the fuel cell exhaust gas can be mixed with the heated ambient air in at least one mixing chamber which receives at least one part of the fuel cell exhaust gas and at least one part of the heated ambient air.

### BRIEF DESCRIPTION OF DRAWINGS

The invention will now be described with reference to the drawings wherein:

FIG. 1 shows an outline illustration of a fuel cell system; and,

FIG. 2 shows an alternative embodiment of a fuel cell exhaust gas/ambient air mixing arrangement of the fuel cell system from FIG. 1.

### DETAILED DESCRIPTION

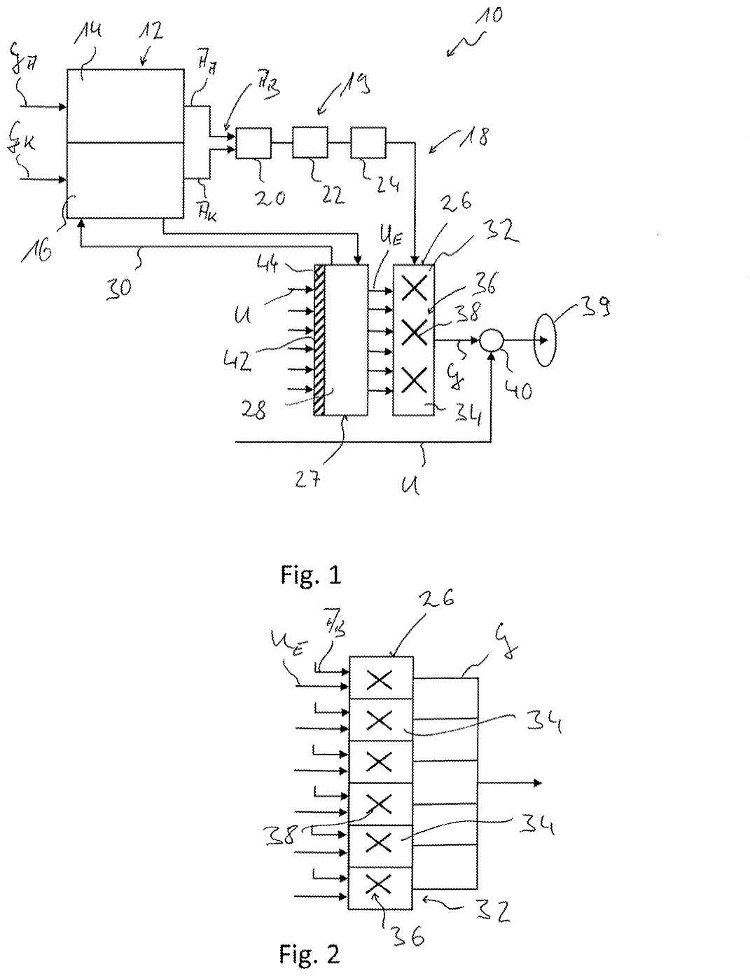

FIG. 1 shows a fuel cell system which is denoted in general by 10 and can be used, for example, in a vehicle for providing electrical energy. The fuel cell system 10 includes a fuel cell arrangement 12 which can be constructed, for example, with one or more fuel cell stacks, and fundamentally includes an anode region 14 which is fed with hydrogen-containing anode gas G_{A} and a cathode region 16 which is fed with oxygen-containing cathode gas G_{K}. In the fuel cell process, with the conversion of the anode gas G_{A} and the cathode gas G_{K}, firstly electrical energy is generated and secondly an anode exhaust gas A_{A} which generally contains residual hydrogen and a cathode exhaust gas A_{K} which generally contains residual oxygen are produced. Depending on the fuel cell type, the anode exhaust gas A_{A} or the cathode exhaust gas A_{K} primarily contains a comparatively high proportion of water or water vapor with a relative humidity in the range of up to from 90 to 100%.

The fuel cell arrangement 12 is assigned a fuel cell exhaust gas system which is denoted generally by 18. In the example which is shown, the fuel cell exhaust gas system 18 receives the anode exhaust gas A_{A} and the cathode exhaust gas A_{K} as fuel cell exhaust gas A_{B}. As an alternative, the exhaust gas system 18 might be constructed in such a way that it receives only that one of the two exhaust gas flows which leave the fuel cell arrangement 12 which is enriched greatly or more greatly with water or water vapor.

A fuel cell exhaust gas treatment arrangement 19 can be arranged in an upstream region of the fuel cell exhaust gas system 18. The fuel cell exhaust gas treatment arrangement 19 can include, for example, a liquid separator 20, in which liquid accumulations or liquid droplets which are contained in the fuel cell exhaust gas A_{B} and are, for example, relatively great can be separated and can be fed, for example, to the fuel cell process. The fuel cell exhaust gas treatment arrangement 19 can include a catalytic converter 22 for aftertreatment of the fuel cell exhaust gas A_{B}, and can have, for example, a silencer 24.

It is to be noted that other or additional assemblies of the fuel cell exhaust gas treatment arrangement 19 can be provided, or individual ones of the three illustrated assemblies of the fuel cell exhaust gas treatment arrangement 19 can be absent in the fuel cell exhaust gas system 18 or can be positioned in a different sequence.

Furthermore, the fuel cell exhaust gas system 18 includes a fuel cell exhaust gas/ambient air mixing arrangement 26. The latter is fed with the fuel cell exhaust gas A_{B} which is possibly treated in one or more of the assemblies of the fuel cell exhaust gas treatment arrangement 19. The fuel cell exhaust gas A_{B} is mixed with heated ambient air U_{E} in the fuel cell exhaust gas/ambient air mixing arrangement 26. To this end, ambient air U which is received from the surroundings is heated in an ambient air heating arrangement 27. The ambient air heating arrangement 27 can include, for example, a heat exchanger 28 which is flowed through by a fuel cell cooling medium, generally a liquid cooling medium, which circulates in a fuel cell cooling circuit 30. For example, the heat exchanger 28 can be provided by way of a vehicle radiator which is present in a vehicle and can be flowed through by the air flow around the vehicle.

The ambient air U which is received from outside absorbs heat from the fuel cell cooling medium in the heat exchanger 28, and then flows as heated ambient air U_{E} to the fuel cell exhaust gas/ambient air mixing arrangement 26. The latter has a mixing volume 32 which, in the example which is shown in FIG. 1, can be formed by way of a single mixing chamber 34 which is provided in the fuel cell exhaust gas/ambient air mixing arrangement 26. The fuel cell exhaust gas A_{B} and the heated ambient air U_{E} are introduced into this mixing chamber 34.

A fuel cell exhaust gas/ambient air mixing arrangement 36 is provided in the mixing volume 32 or the mixing chamber 34 which provides the latter. This mixing arrangement 36 can include one or more mixers 38 which can be configured, for example, with deflection blades which ensure turbulence or a flow deflection, and bring about efficient thorough mixing of the fuel cell exhaust gas A_{B} with the heated ambient air U_{E} as a result and in the process produce a fuel cell exhaust gas/ambient air mixture G which leaves the fuel cell exhaust gas/ambient air mixing arrangement 26. This fuel cell exhaust gas/ambient air mixture G can be output to the surroundings at a downstream end region of the fuel cell exhaust gas system 18 via an outlet opening 39 (shown in outline form).

As a result of the mixing of the fuel cell exhaust gas A_{B} which has a high relative humidity with the heated ambient air U_{E} which has a comparatively low relative humidity, the fuel cell exhaust gas/ambient air mixture G is provided with a relative humidity which is considerably lower than the relative humidity of the fuel cell exhaust gas A_{B} and has a value of far below 100%. If the fuel cell exhaust gas/ambient air mixture G with its relative humidity which lies considerably below a value of 100% exits to the surroundings out of the fuel cell exhaust gas system 18, it comes spontaneously into contact with the cold ambient air U in the case of operation at a comparatively low ambient temperature. This leads to the temperature also decreasing spontaneously as a result of the mixing of the fuel cell exhaust gas/ambient air mixture G with the comparatively cold ambient air U. Since the relative humidity of the fuel cell exhaust gas/ambient air mixture G lies considerably below 100% before this thorough mixing with the ambient air U, the possibility that, in the case of the temperature of the mixture G decreasing during the thorough mixing with the cold ambient air U, the relative humidity exceeds the value of 100% and therefore mist formation as a result of water which condenses out arises practically does not exist.

In order to further decrease the risk of the mist formation during the output of the fuel cell exhaust gas/ambient air mixture G to the outside, unheated ambient air U can be added in the region of an ambient air mixing arrangement 40 to the fuel cell exhaust gas/ambient air mixture G before it is output from the fuel cell exhaust gas system. The ambient air adding arrangement can include a valve system or a flap system, through which, for example, a stream of ambient air U generated by way of the air flow around the vehicle is also introduced into the fuel cell exhaust gas/ambient air mixture G, and the temperature of the fuel cell exhaust gas/ambient air mixture G is already reduced somewhat in this way, the relative humidity of the fuel cell exhaust gas/ambient air mixture G which has already been thoroughly mixed with unheated ambient air U in the fuel cell exhaust gas system 18 still lying considerably below 100%. Thorough mixing of this type can fundamentally also be produced directly at the outlet opening 39 of the fuel cell exhaust gas system 18.

In order for it to be possible for the thermal interaction of the unheated ambient air U, introduced into the heat exchanger 28, with the fuel cell cooling medium to be set in a defined manner, the heat exchanger 28 can be assigned a flow throttling arrangement 42. The latter can include, for example upstream of the heat exchanger 28, a plurality of slats 44 which can be adjusted in order to change the throughflow capability. By way of pivoting the slats 44 and in this way changing the throughflow capability of the flow throttling arrangement 42, the quantity of ambient air U which flows through the heat exchanger 28 is changed. If less ambient air U is introduced into the heat exchanger 28, the heat which is transported in the fuel cell cooling medium is transferred to a smaller air quantity, which can have the consequence that the ambient air U_{E} which leaves the heat exchanger 28 in a heated state is at a higher temperature. Therefore, changes in the relative humidity of the fuel cell exhaust gas A_{B} can be reacted to by way of regulation of the air quantity which flows through the heat exchanger 28 firstly and therefore the temperature of the heated ambient air U_{E} which leaves the heat exchanger 28 secondly, in order for it to be possible in this way for a fuel cell exhaust gas/ambient air mixture G with a minimum possible relative humidity to be produced in the region of the fuel cell exhaust gas/ambient air mixing arrangement.

In order for it to be possible for the heated ambient air U_{E} which is output by the ambient air heating arrangement 27 to be thoroughly mixed efficiently with the fuel cell exhaust gas A_{B}, different measures can be taken, furthermore. For instance, as illustrated in FIG. 1, the heated ambient air U_{E} can be introduced into the mixing chamber 34 distributed over a relatively large area or a plurality of inlet openings. As a result of this introduction of the heated ambient air U_{E} distributed over a large area into the mixing chamber 34, mixing of the heated ambient air U_{E} with the fuel cell exhaust gas A_{B} which is more homogeneous over the entire mixing volume 36 or is distributed in a smaller area is achieved in comparison with the fundamentally also possible introduction at one inlet opening. As an alternative or in addition, the fuel cell exhaust gas A_{B} can also be introduced via a plurality of inlet openings into the mixing chamber 34, in order in this way to achieve a more homogeneous distribution and therefore improved mixing with the heated ambient air U_{E}.

In a further configuration variant which is illustrated in FIG. 2, the mixing volume 32 can be divided into a plurality of mixing chambers 34 which are fundamentally separate from one another. The fuel cell exhaust gas/ambient air mixing arrangement 36 can include in each case one mixer 38 assigned to each of the mixing chambers 34.

Each mixing chamber 34 is fed a part of the fuel cell exhaust gas A_{B} which is output by the fuel cell arrangement 12 and a part of the heated ambient air U_{E} which is output by the heat exchanger 28, and therefore smaller volumetric flows of the fuel cell exhaust gas A_{B} and the heated ambient air U_{E} are mixed efficiently in each mixing chamber 34 by way of at least one mixer 38 which is provided therein. The introduction of the fuel cell exhaust gas A_{B} and the heated ambient air U_{E} into the individual mixing chambers 34 can take place in each case via a single inlet opening or a plurality of inlet openings. In this way, a mixture G of fuel cell exhaust gas and ambient air is produced in each of the mixing chambers 34. The volumetric flows of the fuel cell exhaust gas/ambient air mixture G which are output from the mixing chambers 34 can then be combined and output to the surroundings in the way which is described in relation to FIG. 1. It can also be provided here that the volumetric flows of the fuel cell exhaust gas/ambient air mixture G which exit from the individual mixing chambers 34 are output to the surroundings in each case separately and are mixed with the unheated ambient air. Part flows of the fuel cell exhaust gas/ambient air mixture G which are separated from one another, for example, via a plurality of output openings or output tubes might also be output to the surroundings in the case of the configuration variant which is shown in FIG. 1.

For efficient heating of the ambient air, the ambient air heating arrangement 27 can include an electrically operated heating device, for example, in addition to the possibility of heating the ambient air by way of thermal interaction with the fuel cell cooling medium. This heating device can be operated with electrical energy generated by way of the fuel cell arrangement 12, in particular, in a starting phase of the operation, in which the fuel cell cooling medium is at a comparatively low temperature, in order to efficiently prevent a mist formation in the case of the outlet of fuel cell exhaust gas A_{B} to the surroundings even in a starting phase of the operation of the fuel cell system 10.

It is understood that the foregoing description is that of the preferred embodiments of the invention and that various changes and modifications may be made thereto without departing from the spirit and scope of the invention as defined in the appended claims.

1-20. (canceled)

21. A fuel cell exhaust gas system comprising:
a fuel cell arrangement outputting a fuel cell exhaust gas;
an ambient air heating arrangement for heating ambient air to provide heated ambient air; and,
a fuel cell exhaust gas/ambient air mixing arrangement being configured for receiving said fuel cell exhaust gas and said heated ambient air and being configured to thoroughly mix said heated ambient air with said fuel cell exhaust gas.

22. The fuel cell exhaust gas system of claim 21, wherein:
said fuel cell arrangement includes a fuel cell cooling circuit through which a fuel cell cooling medium flows; and,
said ambient air heating arrangement includes a heat exchanger flowed through by said ambient air for feeding to said fuel cell exhaust gas/ambient air mixing arrangement and flowed through by said fuel cell cooling medium for transmission of heat contained in said fuel cell cooling medium to the ambient air which is to be fed to said fuel cell exhaust gas/ambient air mixing arrangement.

23. The fuel cell exhaust gas system of claim 22, wherein said ambient air heating arrangement includes a flow throttle arrangement for throttling a quantity of the ambient air which is to be fed to said fuel cell exhaust gas/ambient air mixing arrangement and which quantity flows through said ambient air heating arrangement.

24. The fuel cell exhaust gas system of claim 21, wherein said fuel cell exhaust gas/ambient air mixing arrangement includes a mixing volume which receives the ambient air outputted by said ambient air heating arrangement and said fuel cell exhaust gas.

25. The fuel cell exhaust gas system of claim 24, wherein said mixing volume is assigned a fuel cell exhaust gas/ambient air mixing arrangement for mixing the ambient air introduced into said mixing volume with said fuel cell exhaust gas introduced into said mixing volume.

26. The fuel cell exhaust gas system of claim 24, wherein said mixing volume includes a mixing chamber which receives said fuel cell exhaust gas and said ambient air outputted by said ambient air heating arrangement.

27. The fuel cell exhaust gas system of claim 26, wherein said mixing chamber includes at least one of the following: i) a plurality of ambient air inlet openings for introducing ambient air into said mixing chamber; and, ii) a plurality of fuel cell exhaust gas inlet openings for introducing fuel cell exhaust gas into said mixing chamber.

28. The fuel cell exhaust gas system of claim 25, wherein said ambient air/fuel cell exhaust gas mixing arrangement includes at least one mixer assigned to said mixing chamber.

29. The fuel cell exhaust gas system of claim 24, wherein said mixing volume includes a plurality of mixing chambers, each of said mixing chambers being configured to receive a part of the fuel cell exhaust gas and a part of said ambient air outputted by said ambient air heating arrangement.

30. The fuel cell exhaust gas system of claim 29, wherein said fuel cell exhaust gas/ambient air mixing arrangement includes at least one mixer assigned to each mixing chamber.

31. The fuel cell exhaust gas system of claim 25, wherein said fuel cell exhaust gas/ambient air mixing arrangement includes at least one mixer assigned to each mixing chamber.

32. The fuel cell exhaust gas system of claim 21, wherein an ambient air adding arrangement is provided to add ambient air to said fuel cell exhaust gas/ambient air mixture outputted by said fuel cell exhaust gas/ambient air mixing arrangement.

33. The fuel cell exhaust gas system of claim 21, wherein a fuel cell exhaust gas treatment arrangement is arranged upstream of said fuel cell exhaust gas/ambient air mixing arrangement; and, said fuel cell exhaust gas treatment arrangement includes at least one of the following assemblies: liquid separator; catalytic converter; and, silencer.

34. The fuel cell exhaust gas system of claim 21, wherein said fuel cell exhaust gas system is for providing electrical energy in a vehicle.

35. A fuel cell system comprising:
a fuel cell arrangement; and,
a fuel cell exhaust gas system including:
a fuel cell arrangement outputting a fuel cell exhaust gas;
an ambient air heating arrangement for heating ambient air to provide heated ambient air; and,
a fuel cell exhaust gas/ambient air mixing arrangement being configured for receiving said fuel cell exhaust gas and said heated ambient air and being configured to thoroughly mix said heated ambient air with said fuel cell exhaust gas.

36. A method for operating a fuel cell system including: a fuel cell arrangement; and, a fuel cell exhaust gas system having: a fuel cell arrangement outputting a fuel cell exhaust gas; an ambient air heating arrangement for heating ambient air to provide heated ambient air; and, a fuel cell exhaust gas/ambient air mixing arrangement being configured for receiving said fuel cell exhaust gas and said heated ambient air and being configured to thoroughly mix said heated ambient air with said fuel cell exhaust gas; the method comprising the steps of:
producing a mixture from the fuel cell exhaust gas outputted by the fuel cell arrangement of the fuel cell system; and,
heating at least one part of the ambient air added to the fuel cell exhaust gas before mixing with the fuel cell exhaust gas.

37. The method of claim 36, wherein unheated ambient air is added to the mixture of fuel cell exhaust gas and heated ambient air.

38. The method of claim 36, wherein the fuel cell arrangement includes a fuel cell cooling circuit through which a fuel cell cooling medium flows; and, wherein the ambient air, which is to be mixed in a heated state with the fuel cell exhaust gas, is heated in a heat exchanger by way of thermal interaction with the fuel cell cooling medium.

39. The method of claim 38, wherein, in order to set a temperature of the ambient air to be heated in the heat exchanger, a mass flow of the ambient air which flows through a heat exchanger and/or a mass flow of the fuel cell cooling medium which flows through the heat exchanger are/is changed.

40. The method of claim 36, wherein the fuel cell exhaust gas is mixed with the heated ambient air in at least one mixing chamber which receives at least one part of the fuel cell exhaust gas and at least one part of the heated ambient air.
